(19) United States
(12) Patent Application Publication
(10) Pub. No.: US 2003/0024720 A1
(43) Pub. Date: Feb. 6, 2003

(54) Weatherproof junction box

(76) Inventor: Eric O.M. Haddad, East Berlin, PA (US)

Correspondence Address: MIDDLETON & REUTLINGER, 2500 BROWN & WILLIAMSON TOWER, LOUISVILLE, KY, 40202

(21) Appl. No.: 09/515,532

(22) Filed: Feb. 29, 2000

(51) Int. Cl. H02G 3/08; H01J 5/00

(52) U.S. Cl. 174/50

(57) ABSTRACT

A weatherproof junction box which may be mounted in non-traditional locations is provided by the present invention. The junction box includes a housing member or splice compartment with at least two threaded openings. The splice compartment is attached to a mounting bracket that is designed to receive lag bolts or straps, which may be used to mount the junction box to a tree, pole, wall or similar structures. The junction box also includes a twist-to-open lockable cover that provides easy access to the interior of the splice compartment, even when the junction box is mounted.

### BACKGROUND OF THE INVENTION

1. Field of the Invention

The invention generally relates to electrical conduit outlet fittings, and more particularly to weatherproof junction boxes for electrical outlets.

2. Description of the Related Art

Gasketless junction boxes for use in wet locations are known in the art. However, current weatherproof junction boxes do not provide for easy topside access to their splice compartments when the boxes are mounted in place. The design of current weatherproof junction boxes often includes access routes that are positioned opposite from the conduit entries of the box. These designs often necessitate the dismounting of the junction box before access to its interior may be had. Additionally, current weatherproof junction boxes are not designed to be easily mounted to a tree or a pole with the use of lag bolts or straps. The ability to mount a junction box to these structures expands the scope of the use of electrical fixtures and provides for a simple and inexpensive means for mounting lighting and other electrical fixtures in non-traditional outdoor locations.

Thus, there is a need for an electrical junction box that is weatherproof and that may be easily mounted in non-traditional outdoor locations. Such a junction box should also provide for easy access to its interior while mounted, so that its use may be optimized.

### SUMMARY OF THE INVENTION

It is an object of the present invention to provide a gasketless weatherproof junction box for electrical fixtures.

It is another object of the present invention to provide a weatherproof junction box that may be mounted to a tree, pole or similar structure with bolts or straps.

It is yet another object of the present invention to provide a junction box that has a lockable cover that provides easy access to the splice compartment while the box is mounted.

More particularly, the present invention provides a weatherproof junction box that includes a splice compartment attached to a mounting bracket. The splice compartment has a conduit entry through the bottom of the compartment and a fixture insert through side of the compartment. A cover attaches to the splice compartment to form a weatherproof gasketless seal at the access opening of the compartment. The cover includes at least one inwardly projecting lug that engages at least one lug projecting outwardly from the side wall of the splice compartment. These lugs provide for the weatherproof sealing of the splice compartment. The cover may be easily removed from the compartment in order to access its interior while the box is mounted. The splice compartment may be integrally formed with the mounting bracket or releasably attached thereto. The mounting bracket contains at least one hole for receiving a lag bolt and another aperture for threading a strap there through.

It will become apparent that other objects and advantages of the present invention will be obvious to those skilled in the art upon reading the detailed description of the preferred embodiment set forth hereinafter.

### BRIEF DESCRIPTION OF THE DRAWINGS

FIG. 1 is a perspective view of a junction box of the present invention.

FIG. 2 is a cross-sectional view of the junction box of FIG. 1 taken along lines 2-2.

FIG. 3 is a top view of the junction box of FIG. 1 with the cover removed.

FIG. 4 is a cross-sectional view of the junction box of FIG. 3 taken along lines 4-4.

FIG. 5 is an exploded perspective view of the junction box of the present invention turned 90° from FIG. 1.

FIG. 6 is a perspective view of the cover of the junction box of the present invention.

### DESCRIPTION OF THE PREFERRED EMBODIMENT

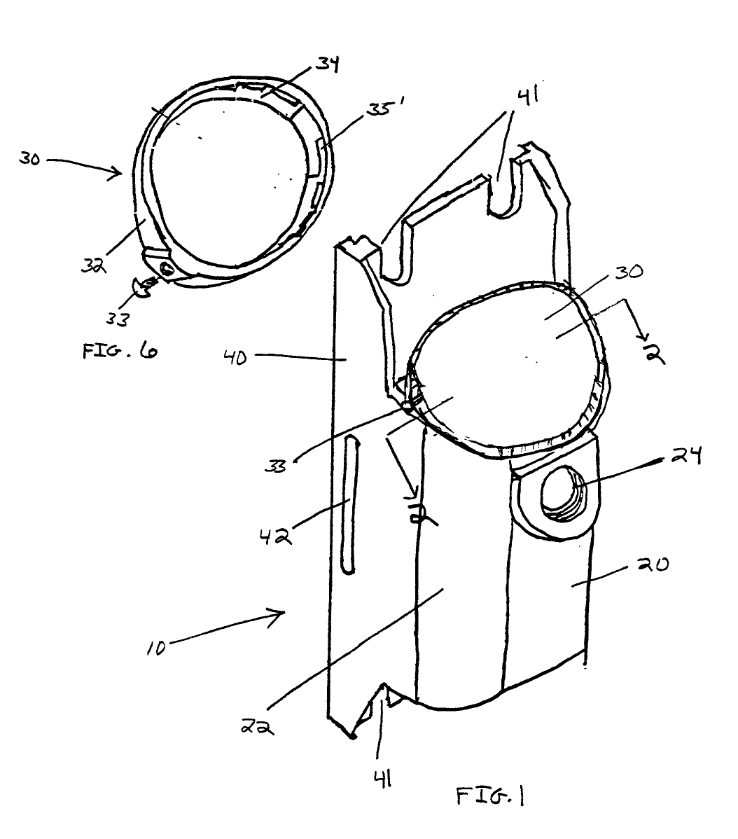

As shown in FIG. 1, a weatherproof junction box 10 includes a housing member or splice compartment 20, a cover 30 and a mounting bracket 40. The junction box 10 may be mounted to a tree, pole or similar structure by the use of lag bolts or straps (not shown) attached to the mounting bracket 40. Additionally, the junction box 10 may also be mounted on a wall or flat structure by the use of lag bolts (not shown).

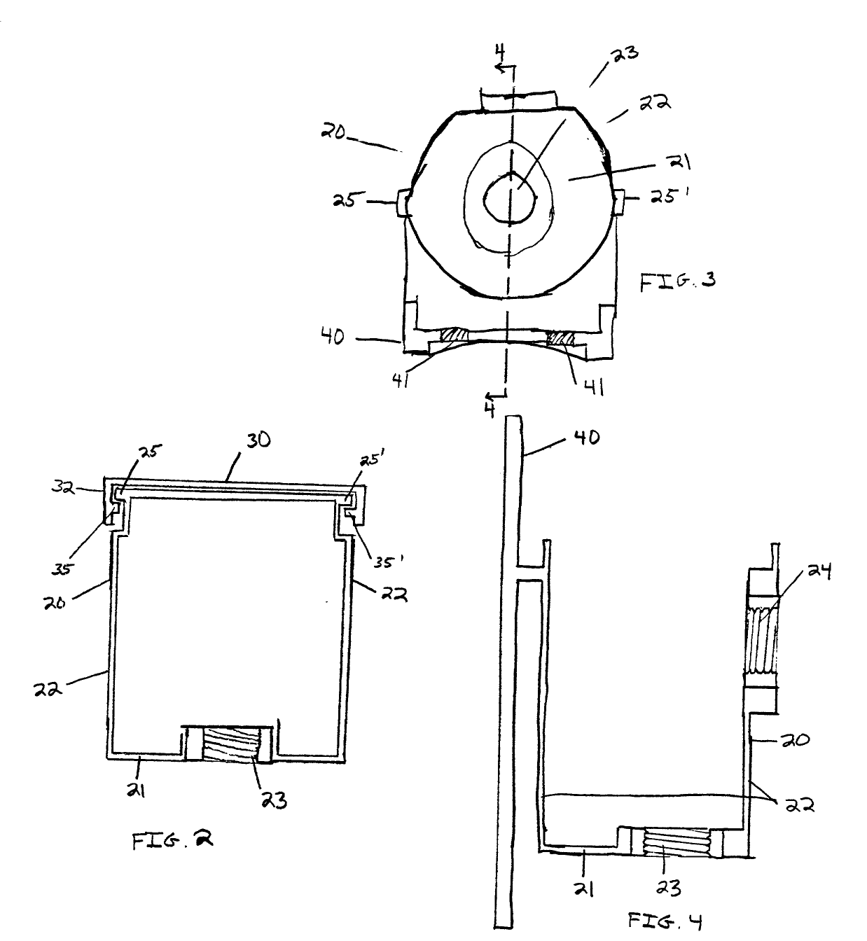

As shown in FIGS. 2-5, the splice compartment 20 includes a bottom wall 21 and a side wall 22. The side wall 22 may be generally cylindrical, as shown in FIG. 3, or any other convenient shape and includes at least one threaded fixture insert 24. The bottom wall 21 is attached to the side wall 22 and includes at least one conduit entry 23 therein. The conduit entry 23 is a female threaded opening through which electrical wiring 51 may enter the splice compartment 20. During normal usage of the junction box 10, a conduit (not shown) containing electrical wiring would be threadably attached to conduit entry 23. A lighting fixture (not shown) or another electrical fixture may be attached to fixture insert 24. The spliced connection of between the electrical wiring and the fixture would be housed in the housing member 20.

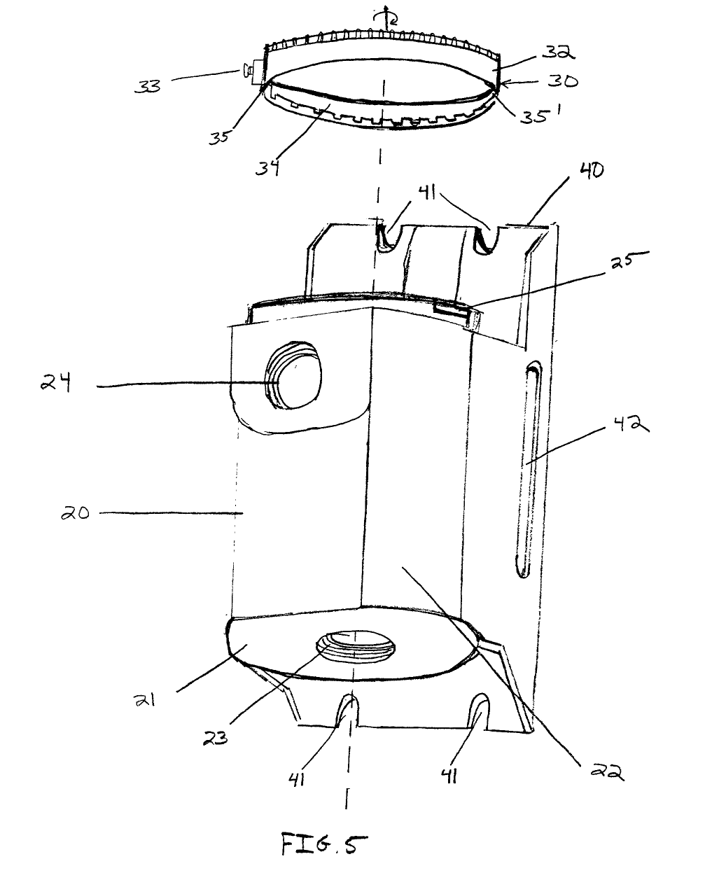

Side wall 22 includes at least one lug 25 projecting from a surface thereof. In the preferred embodiment, two lugs 25 and 25′ project outwardly from the outer surface of the side wall 22 and are positioned diametrically opposed to each other, as shown in FIGS. 2 and 3. Cover 30 also has at least one lug 35 projecting therefrom. As shown in FIG. 2, the preferred embodiment includes two lugs 35 and 35′ projecting inwardly from the skirt 32 of cover 30 and are positioned diametrically opposed to each other. Cover 30 may also include a fastening means, such as a screw 33, as shown in FIG. 5. As shown in FIGS. 5 and 6, cover 30 may also include at least one rib 34 that projects inwardly along part of the inner circumference of skirt 32.

Cover 30 may be attached to housing member 20 by aligning lug 25 between rib 34 and lug 35 and lug 25′ between rib 34′ and lug 35′. After the cover 30 is so aligned, it may then be placed on housing member 20. Cover 30 may then be turned in the appropriate direction, as shown in FIG. 5, so that lug 35 slides under lug 25 and lug 35′ slides under lug 25′. When force is applied to cover 30 to remove it from housing member 20, lug 35 and 35′ engage 25 and 25′, respectively, thereby preventing the removal of cover 30. Screw 33 may then be threadably tightened so that it will engage lug 25 if the cover 30 is turned in the opposite direction. The engagement of screw 33 and lug 25 prevents the cover from being turned to the position where lug 25 and lug 34 are no longer engaging each other. Thus, when screw 33 is thus tightened, cover 30 is locked in place on housing member 20.

As shown in FIG. 5, mounting bracket 40 includes at least one and preferably a plurality of openings 41 therein which may receive a lag bolt or other similar fastening means. Junction box 10 may be mounted to a tree, pole, wall or similar structure by inserting a fastening means, such as lag bolts (not shown) through one or more openings 41 and then attaching the fastening means to the structure to which the junction box 10 is to be mounted. Additionally, as shown in FIG. 1, mounting bracket 40 includes an opening 42 that may receive a strap, chain or similar fastening means that may be use to secure the junction box 10 to a structure. In the preferred embodiment, mounting bracket 40 includes two openings 42 through which a support strap (not shown) may be threaded. The support strap may be attached to a tree, pole or similar structure so as to secure the junction box 10 to that structure.

Although mounting bracket 40 is shown in the figures as being integrally attached to housing member 20, the present invention also includes a housing bracket 20 that may be releasably attached to mounting bracket 40. For example, mounting bracket 40 may include one or more grooves (not shown) that may receive one or more beads located on the housing member 20. The engagement of these grooves and beads can thereby secure the housing member 20 to the mounting bracket 40. Furthermore, other fastening means, such as screws or clips, well known in the art may be used to fasten housing member 20 to mounting bracket 40.

Junction box 10 may be formed from any weather resistant nonconductive material well known in the art, such as a molded plastic of polypropylene or polyvinyl chloride. In a preferred embodiment, the junction box 10 is formed of a molded polymer composite, such as VALOX. Junction box 10 may also comprise metal parts, such as brass or aluminum. More particularly, in the preferred embodiment, conduit entry 23 and threaded opening 24 may include threaded brass fittings molded into the body of a nonconductive housing member 20.

While the invention has been found in this preferred embodiments in respect to the design of the junction box and the use thereof, it is apparent that various modifications can be made to the present invention without departing from the spirit or scope of the invention as set forth in the claims appended hereto.

What is claimed is:

1. A junction box comprising:
a housing member having a bottom wall and a side wall, said bottom wall including at least one first threaded opening therein, said side wall including at least one second threaded opening therein and at least one first lug projecting outwardly therefrom;
a cover releasably attached to said housing member, wherein said cover includes a top wall and a skirt depending from said top wall, said skirt including at least one second lug projecting inwardly therefrom, said second lug being releasably engaged with said first lug;
a mounting brace attached to said housing member, said mounting brace including at least one hole therein.

2. The junction box of claim 1, wherein said first threaded opening and said second threaded opening being formed of a metal.

3. The junction box of claim 2, wherein said metal is aluminum.

4. The junction box of claim 2, wherein said metal is a copper alloy.

5. The junction box of claim 4, wherein said copper alloy is brass.

6. The junction box of claim 1, wherein said mounting brace is integrally attached to said housing member.

7. The junction box of claim 1, wherein said cover includes a fastening means attached thereto.

8. The junction box of claim 7, wherein said fastening means is a screw.

9. The junction box of claim 1, wherein said housing member, said mounting brace said cover are formed of a polymeric material.

10. The junction box of claim 9, wherein said polymeric material is a composite.

11. The junction box of claim 10, wherein said composite is VALOX.

12. The junction box of claim 9, wherein said polymeric material is polyvinyl chloride.

13. The junction box of claim 9, wherein said polymeric material is polypropylene.

14. The junction box of claim 1, wherein said housing member forms a gasketless seal with said cover, when said cover is attached thereto.
